(19) United States
(12) Patent Application Publication
(10) Pub. No.: US 2014/0039074 A1
(43) Pub. Date: Feb. 6, 2014

(54) METHOD FOR RAPID PREPARATION OF SUITABLE [18F]FLUORIDE FOR NUCLEOPHILIC [18F]FLUORINATION

(71) Applicants: Dae Yoon Chi, Seoul (KR); Byoung Se Lee, Incheon (KR); Sang Ju Lee, Seoul (KR); Jin-Sook Ryu, Seoul (KR); Seung Ju Oh, Seoul (KR)

(72) Inventors: Dae Yoon Chi, Seoul (KR); Byoung Se Lee, Incheon (KR); Sang Ju Lee, Seoul (KR); Jin-Sook Ryu, Seoul (KR); Seung Ju Oh, Seoul (KR)

(73) Assignee: PIRAMAL IMAGING SA, Matran (CH)

(21) Appl. No.: 13/821,638

(22) PCT Filed: Sep. 6, 2011
(86) PCT No.: PCT/EP2011/065366

§ 371 Date: Oct. 18, 2013

(30) Foreign Application Priority Data
Sep. 9, 2010 (EP) 10009380.6

(51) Int. Cl. C07B 59/00; B01J 41/14

(52) U.S. Cl. CPC C07B 59/005; B01J 41/14; C07B 59/002; C07B 59/001
USPC 521/33; 521/38; 536/119; 546/132; 536/28.54; 548/327.5; 564/442; 558/403; 546/300; 423/249; 252/184

(57) ABSTRACT

The invention generally relates to the preparation of ¹⁸F-labeled radiopharmaceuticals. In particular, this invention relates to the advanced processes for an efficient eiution of [¹⁸F]fluoride trapped in a cartridge filled with quaternary ammonium polymer which comprises inert non-basic and non-nucleophilic counter anions. The said methods and polymer cartridges allow the rapid preparation of suitable [¹⁸F]fluoride solution, which is also less basic to reduce the formation of byproducts, finally to increase radiochemical yield and purity of ¹⁸F-radiopharmaceuticals.

### FIELD OF THE INVENTION

The invention generally relates to the preparation of ¹⁸F-labeled radiopharmaceuticals. In particular, this invention relates to the advanced processes for an efficient elution of [¹⁸F]fluoride trapped in a cartridge filled with a quaternary ammonium polymer which comprises inert non-basic and non-nucleophilic counter anions. The said methods and polymer cartridges allow the rapid preparation of a suitable [¹⁸F]fluoride solution which is also less basic to reduce the formation of byproducts, finally to increase the radiochemical yield and purity of ¹⁸F-radiopharmaceuticals.

### KEYWORDS

¹⁸F-labeled radiopharmaceuticals, tertiary alcohols, quaternary ammonium polymer, eluting solution, rapid drying,

### AIM OF THE INVENTION

The invention aims to prepare ¹⁸F-labeled radiopharmacueticals in high radiochemical yield and purity through the rapid process of separation/elution of [¹⁸F]fluoride ion by using an inert quaternary ammonium polymer cartridge and a volatile eluting solution.

### BACKGROUND OF THE INVENTION

Positron emission tomography (PET) is an emerging technology to image and diagnose numerous human diseases at an early stage. [P. W. Miller, N. J. Long, R. Vilar, A. D. Gee, Angew, Chem. Int, Ed, 2008, 47, 8998-9033] Of several positron-emitting radionuclides produced from a cyclotron, [¹⁸F]fluoride is thought to have the most suitable chemical and physical properties for diagnostic radiopharmaceuticals. The atomic size of fluorine is similar to hydrogen and the fluorine offers improved lipophilicity to fluorine-containing compounds as well as inertness to metabolic transformations.

[¹⁸F]Fluoride can be readily prepared from medical cyclotron, and has a proper half-life of about 110 min. [M. C. Lasne, C. Perrio, J. Rouden, L. Barre, D, Roeda, F. Dolle, C. Crouzel, Contrast Agents II, Topics in Current Chemistry, Springer-Verlag, Berlin, 2002, 222, 201-258.; R. Bolton, J. Labelled Compd. Radiapharm, 2002, 45 485-528].

Commonly, [¹⁸F]fluoride produced from the cyclotron exists in a highly diluted enriched O-18 water solution. [M. R. Kilbourn, J. T. Hood, M. J. Welch, Int. J. Appl. Radiat. Isot. 1984, 35, 599.; G. K, Mulholland, R. D, Hichwa, M. R. Kilbourn, J. Moskwa, J. Label, Compd. Radiopharm. 1989, 26, 140] Enriched O-18 water is very expensive and contains trace amount of metal cations after irradiation, which may influence the ¹⁸F-labeling reaction.

Some cartridges containing an anion-exchange resin are usually utilized to separate [¹⁸F]fluoride from enriched O-18 water and remove trace metal cations by solid phase extraction, [K.—I, Nishijima, Y. Kuge, E, Tsukamoto, K, —I, Seki, K, Ohkura, Y. Magaia, A, Tanaka, K. Nagatsu, N. Tamaki. Appl. Radiat. Isot. 2002, 57, 43.; D. Schoeller, Obes. Res. 1999, 7, 519.; SNM Newsline, J. Nucl. Med, 1991, 32, 15N; D. J. Schlyer, M. Bastos, A. P. Wolf, J. Nucl. Med. 1987, 28, 764.; S. A. Toorongian, G. K. Mulholland, D. M. Jewett, M. A. Bachelor, M. R. Kilbourn, Nucl. Med. Biol. 1990, 17, 273.; D. M. Jewett, S. A. Toorongian, G. K. Mulholland, G. L. Watkins, M. R, Kilbourn, Appl, Radiat. Isot. 1988, 39, 1109,; G. K. Mulholland, R. D. T. J. Mangner, D. M. Jewett, M. R. Kilbourn, J. Label. Compd. Radiopharm. 1989, 26, 378.; K. Ohsaki, Y. Endo, S. Yamazaki, M. Tomoi, R. Iwata, Appl. Radiat. Isot. 1998, 49, 373-378.]

Chromafix® and QMA cartridges are routinely used in automated radiolabeling as well as manual synthesis, and commercially available. They comprise bicarbonate and chloride counter anions, respectively. These anions possess somewhat basic and nucleophilic properties so that they may cause stability problems in long term storage. In other words, these basic anions can attack internally labile benzyl carbon atoms, resulting in free volatile tertiary amines.

To activate QMA cartridges, the chloride counter anions are exchanged with carbonate anions by eluting aqueous potassium carbonate solution before use. After the respective activation process, both Chromafix® and QMA have enough basic anions inside of the cartridge for the nucleophilic [¹⁸F]fluorination reaction. In addition, excess potassium carbonate in aqueous solution is usually used for complete release of [¹⁸F]fluoride out of these cartridges. The final [¹⁸F]fluoride solution after elution contains excess base and water.

Excess base may cause numerous side reactions including elimination and hydroxylation. Such byproduct analogues result in difficult purification of desired ¹⁸F-labeled product and low specific activity.

Large amounts of water are needed to be removed using repeated azeotropic evaporation with acetonitrile to make the reactive anhydrous [¹⁸F]fluoride ion. Protic solvents including water are known to diminish the nucleophilicity of [¹⁸F]-fluoride by building a strong hydrogen bond with [¹⁸F]fluoride. Complete evaporation requires 15-20 min, consuming 8-12% radioactivity of [¹⁸F]fluoride. This tedious evaporation process also plays a critical role in low and fluctuated reproducibility of both manual and automated synthesis.

A pioneering attempt related to [¹⁸F]-fluorination is disclosed in [J. W. Seo, E. P. Hong, B. S. Lee, S. J. Lee, S. J. Oh, D. Y. Chi, J. Labelled Compd. Radiopharm. 2007, 50 (Suppl. 1), S164], wherein a volatile alcoholic solution containing neutral ammonium-based organic salts is used to elute [¹⁸F]-fluoride trapped in polymer cartridge, resulting in great reduction of the drying time up to 1-2 min and significant suppression of side reactions.

However, neutral ammonium salts may make HPLC purification difficult by contaminating the HPLC column. That method is, therefore, limited only to the manual radiolabeling with small radioactivity. This practical restriction illustrates the need for a further advanced method suitable for the automated synthetic system.

In the invention described herein, nucleophilic [¹⁸F]fluorination is performed using tertiary alcohol solvents to avoid the formation of byproducts according to the state of the art. [D. W. Kim, D.-S. Ahn, Y—H. Oh, S. Lee, H. S. Kil, S. J. Oh, S. J. Lee, J. S. Kim, J.-S. Ryu, D. H. Moon, D. Y. Chi, J. Am. Chem. Soc. 2006, 126, 16394-16397.; D. H. Moon, D. Y. Chi, D. W. Kim, S. J. Oh, J.-S. Ryu. PCT, WO 2006/065038 A1]

### BRIEF DESCRIPTION OF THE FIGURES

FIG. 1. Schematic representation of the present invention. (A) quaternary ammonium polymers consisting of tertiary amines and inert counter anions which have no nucleophilicity; (B) alcoholic eluting solution consisting of K222. KOMs, and TBAHCO₃ for fast evaporation and mild basicity.

FIG. 2. A graph displaying the released radioactivity of [¹⁸F]-fluoride by eluting solution (Eluent A) out of quaternary ammonium polymers 6.

FIG. 3. A graph displaying the released radioactivity of [¹⁸F]fluoride by eluting solutions (Eluent A, B, and C) out of quaternary ammonium polymer 6-3.

### AIMS OF THE INVENTION

The invention relates to pretreatment of [¹⁸F]fluoride for an efficient nucleophilic [¹⁸F]fluorination reaction.

This invention provides a stable neutral ionic polymer.

This invention further provides a method for the synthesis of the neutral ionic polymer.

This invention provides a cartridge by filling with the said ionic polymer.

This invention further provides a method for the separation of [¹⁸F]fluoride from enriched 0-18 water.

This invention provides volatile solutions to release [¹⁸F]fluoride trapped in the said cartridge.

This invention further provides a method to formulate the volatile eluting solution.

This invention provides a method to release [¹⁸F]fluoride trapped in the said cartridge using the said eluting solution.

This invention further provides a method to reduce the evaporation time using the said cartridge and eluting solution.

This invention provides a method to increase the radiochemical yield (RCY) of the nucleophilic [¹⁸F]fluorination by reducing the evaporation time.

This invention further provides a method to increase the RCY of the nucleophilic [¹⁸F]fluorination by using less basic said eluting solution.

This invention provides a method to decrease the amount of precursor for the ease of purification by decreasing the basicity of the nucleophilic [¹⁸F]fluorination condition.

### DETAILED DESCRIPTION

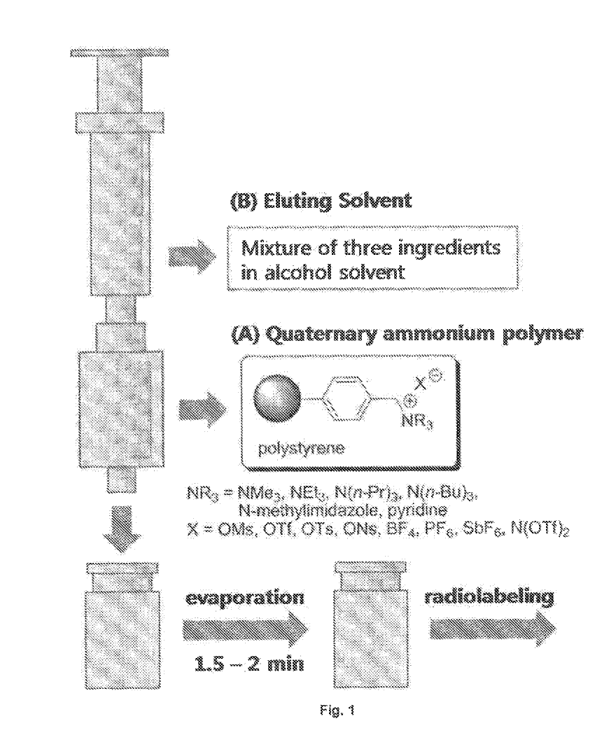

The present invention generally relates to nucleophilic [¹⁸F]fluorination, which takes place in liquid reaction media. As shown in FIG. 1, this invention comprises two important advanced technologies. One is about quaternary ammonium polystyrene having neutral counter anion which has no nucleophilicity and basicity. The other is about volatile eluting solution which consists of K222, KOMs (or KOTf, or K₃PO₄), and TBAHCO₃(or TBAOH, or KOH, or K₂CO₃, or KHCO₃). The present invention not only achieves a short time for preparation of [¹⁸F]fluorination solution to save radioactivity of [¹⁸F]fluoride, but also produces less basic [¹⁸F]fluoride solution for selective [¹⁸F]fluorination.

The detailed present invention is described below.

In the text of the present invention, a series of quaternary ammonium polymer as illustrated in Formula 1.

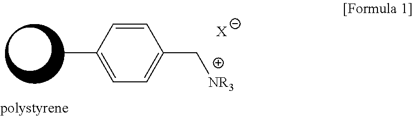

Wherein R is selected from the group consisting of C1-C4 alkyl chains; 5-membered or 6-membered heterocyclic compounds having a nitrogen atom;

X is an inert alkylsulfonate or perfluoride ion having no nucleophilicity; polystyrene is the copolymer consisted of styrene, styrene derivative, and divinylbenzene (DVB).

More detailed,

NR₃ is selected from the group consisting of trimethylamine, triethylamine, tri-n-propylamine, tri-n-butylamine, N-methylimidazole, and pyridine;

X is selected from the group consisting of methanesulfonate (OMs), trifluoromethanesulfonate (OTf), para-toluenesulfonate (OTs), para-nitrobenzenesulfonate (ONs), tekrafluoroborate (BF₄), hexafluorophosphate (PF₆), hexafluoroantimonate (SbF₆), and N,N-bis(trifluoromethanesulfonyl)imide (N(Tf)₂);

polystyrene is an insoluble copolymer consisting of styrene and styrene derivative, which are cross-linked with 10-90 v/v % of divinylbenzene.

In embodiments of the present invention, the said polymer may be prepared by two synthetic pathways as shown in Scheme 1.

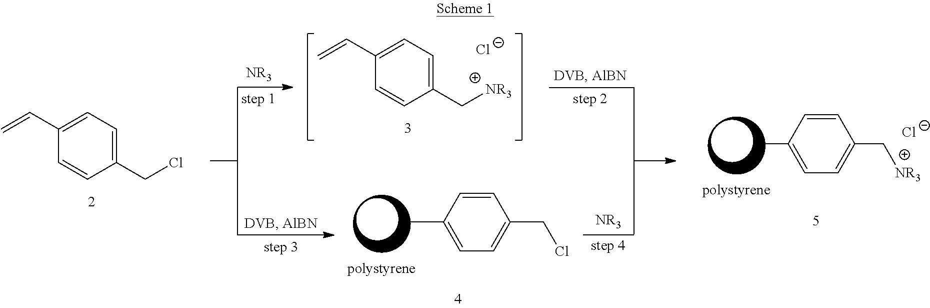

(Wherein NR₃ and polystyrene are defined above)

The first pathway (upper arrow) comprises tandem two steps. The 4-Vinylbenzyl ammonium chloride (3) intermediate is synthesized by the reaction of 4-vinylbenzyl chloride (2) and excess tertiary amine as defined above (step 1). VVithout purification, the intermediate 3 is in situ polymerized with divinylbenzene crosslinker initiated by azobisisobutyronitrile (AIBN) to give the solid polystyrene 5 (step 2). In the first step, the reaction media is selected from the group consisting of THF, CCl₄, CHCl₃, 1,2-dichloroethane, acetonitrile, DMF. DMSO, and water. The mixed solvent of water and DMF is proper as reaction media. The reaction in step 1 is performed at 50° C. for 3-12 h. In the second step, the reaction is performed at 70° C. for 3-12 h.

The second pathway (low arrow) comprises two separate steps. 4-Vinylbenzyl chloride (2) is polymerized with DVB crosslinker initiated by AIBN to give solid polystyrene 4, which is purified by washing and solid phase extraction using a Soxhlet apparatus (step 3). The ammonium chloride polymer 5 is prepared by quaternization of polymer 4 with excess tertiary amine as defined above (step 4).

In step 3, the reaction media is selected from the group consisting of THF, CCl₄, CHCl₃, 1,2-dichloroeihane, monochlorobenzene, acetonikrile, DMF. DMSO, and water. Monochlorobenzene or DMF is suitable as reaction media. The reaction in step 3 is performed at 70° C. for 3-12 h. In step 4, the reaction media is selected from the group consisting of THF, CCl₄, CHCl₃, 1,2-dichloroethane, acetonitrile, DMF. DMSO, and water. The mixed solvent of water and DMF is proper as the reaction media. The reaction in step 4 is performed at 70° C. for 3-24 h.

In embodiments of the present invention, the ammonium chloride polymer 5 is treated with aqueous MX solution for anion exchange from chloride to the inert X anion as shown in Scheme 2.

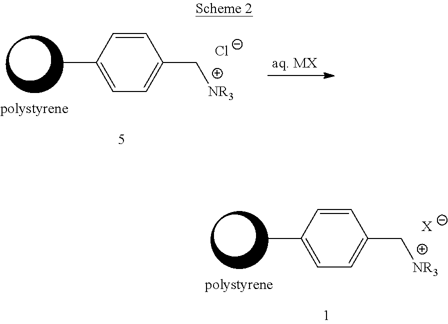

(Wherein NR₃. X, and polystyrene are defined above)

In Scheme 2, M is selected from the group consisting of lithium (Li), sodium (Na), potassium (K), 1-n-butyl-3-methylimidazolium ([bmim]), pyridinium, substituted pyridinium, phosphonium, and NR₄ (R=Me, Et, n-Pr, n-Bu). The anion exchanging process is carried out as follows;
1) the ammoniurn chloride polymer 5 is placed in a funnel or syringe equipped h a polyethylene frit.
2) the aqueous MX solution is added to the funnel or syringe.
3) the suspension is well agitated for 3-10 min.
4) the solution is filtered out under reduced pressure.
5) the resulting polymer is washed with distilled water.
6) repeat above 2-5 steps several times.
7) the polymer is washed with acetone and dried under vacuum.

In embodiments of the present invention, the said polymer 1 is used to make a more stable and efficient solid phase extraction cartridge to separate [¹⁸F]fluoride and to prepare a less basic [¹⁸F]fluoride solution.

For complete releasing [¹⁸F]fluoride out of the said cartridge and fast evaporation, an effective eluting solution is prepared by composing K222, KOMs (or KOTf, K₃PO₄), and TBAHCO₃ (or TBAOH, or KOH, or K₂CO₃. or KHCO₃). Wherein K₂₂₂ is the most effective phase transfer catalyst in nucleophilic [¹⁸F]fluorination; KOMs and KOTf are the source of inert anion instead of TBAOMs disclosed in KP application #10-2008-0078233 for complete solid phase extraction of [¹⁸F]fluoride; K₃PO₄, TBAHCO₃, TBAOH, KOH, K₂CO₃, and KHCO₃ are used to keep reaction solution basic. These components are diluted in an alcohol solvent which is selected form the group consisting of primary alcohol such as methanol, ethanol, n-propanol, n-butanol, n-pentanol, n-hexanol, n-heptanol, and n-octanol; or sencondary alcohol such as isopropanol, isobutanol, isoamyl alcohol, and 3-pentanol; or tertiary alcohol such as t-butanol, t-amyl alcohol, 2,3-dimethyl-2-butanol, 2-(trifluoromethyl)-2-propanol, 3-methyl-3-pentanol, 3-ethyl-3-pentanol, 2-emthyl-2-pentanol, 2,3-dimethyl-3-pentanol, 2,4-dimethyl-2-pentanol, 2-methyl-2-hexanol, 2-cyclopropyl-2-propanol, 2-cyclopropyl-2-butanol, 2-cyclopropyl-3-methyl-2-butanol, 1-methylcyclopentanol, 1-ethylcyclopentanol, 1-propylcyclopentanol, 1-methylcyclohexanol, 1-ethylcyclohexanol, 1-methylcycloheptanol.

In embodiments of the present invention, the eluted [¹⁸F]fluoride solution out of the said polymer cartridge is evaporated under a gentle now of N₂ or He gas and low vacuum. The small amount of water is then removed by azeotropic evaporation with acetonitrile under a gentle flow of N₂ or He gas and low vacuum.

The content of the present invention is not limited to EXAMPLES below.

### EXAMPLES

### Example 1

### Synthesis of Trim Hylammonium Chloride Polystyrene (5-1)

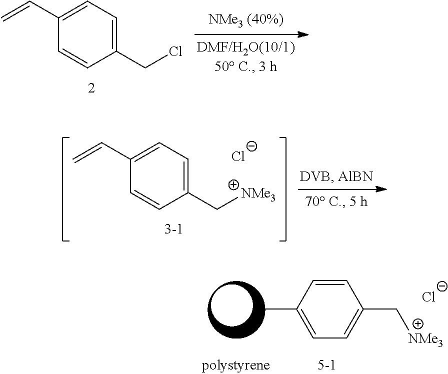

After dissolving 4-vinylbenzyl chloride (2, 1.00 mL, 7.096 mmol) in a mixed solution of water (0.5 mL) and DMF (5.0 mL), 40% trimethylamine aqueous solution (2.098 mL, 14.190 mmol) was added to the solution. The reaction mixture was stirred at 50° C. for 3 h to give N-(4-vinylbenzyl)trimethylammonium chloride (3-1) (step 1). After cooling to room temperature, divinylbenzene (2.00 mL, 11.233 mmol) and AIBN (301 mg, 1.833 mmol) were added and dissolved completely. The reaction mixture was heated at 70° C. for 5 h, and then cooled to room temperature. The resulting polymeric solid (5-1) was roughly crushed and transferred into a 400 mesh sieve, and then was washed with acetone several times (step 2). After drying the polymeric solid under atmosphere, it was grinded in a mortar to result in small particles, and then sorted by particle size using stacked four different sieves to give trimethylammonium chloride polystyrene (5-1); 50-100 mesh: 2.25 g, 100-200 mesh: 0.248 g, 200-400 mesh 0.208 g.

### Example 2

### Synthesis of Triethylammonium Chloride Polystyrene (5-2)

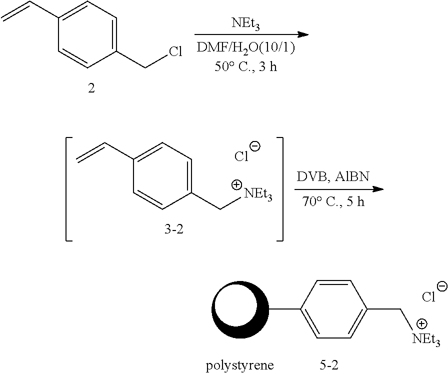

Using triethylairne (1.978 mL, 14.190 mmol) instead of trimethylamine of example 1 above, and following the same procedure and reaction scale as example 1, triethylammonium chloride polystyrene (5-2) was obtained as follows; 50-100 mesh: 2.374 g, 100-200 mesh: 0.487 g, 200-400 mesh: 0.221 g.

### Example 3

### Synthesis of N-Methylimidazolium Chloride Polystyrene (5-3)

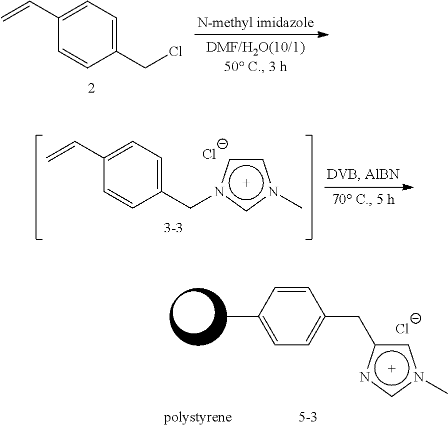

Using N-methylimidazole (1.131 mL, 14.190 mmol) instead of trimethylamine of example 1 above, and following the same procedure and reaction scale as example 1. N-methylimidazolium chloride polystyrene (5-3) was obtained as follows; 50-100 mesh: 1.120 g. 100-200 mesh: 1.377 g, 200-400 mesh: 0.189 g.

### Example 4

### Synthesis of Pyrimidinium Chloride Polystyrene (5-4)

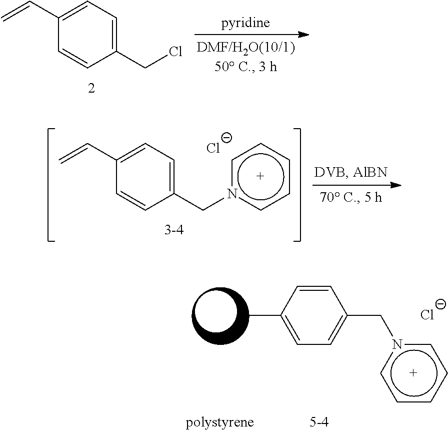

Using pyridine (1.148 mL, 14.190 mmol) instead of trimethylamine of example 1 above, and following the same procedure and reaction scale as example 1, pyrimidinium chloride polystyrene (5-4) was obtained as follows; 50-100 mesh: 1.719 g, 100-200 mesh: 0.206 g, 200-400 mesh: 0.582 g.

An elemental analysis of four ammonium chloride polymers obtained from above examples 1-4 was obtained and the amount of ammonium ion of resins was calculated on the basis of nitrogen content (%) as shown in Table 1,

TABLE 1

| compound | tertiary amine | theoretical (mmol/g) | empirical (mmol/g) |
|---|---|---|---|
| 5-1 | NMe₃ | 2.130 | not determined |
| 5-2 | NEt₃ | 1.955 | 2.023 |
| 5-3 | N-methyl | 2.031 | 1.964 |
| | imidazole | | |
| 5-4 | Pyridine | 2.044 | 2.314 |

### Example 5

### Preparation of Trimethylammonium Methanesulfonate Polystyrene (1-1)

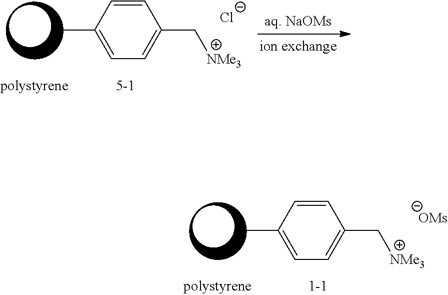

Polymer 5-1 (100-200 mesh, 200 mg) obtained from example 1 was placed into a syringe equipped with a polyethylene frit. Distilled water (10 mL) was added into the syringe and eluted out after 1 min. The syringe was flushed with 0.2 M NaOMs aqueous solution (5 mL) and capped with a tight lid, and then shaked for 3 min. The solution was removed by filtration under reduced pressure and the resin was washed with distilled water. After the ion exchange process was repeated four times, the resin was washed with distilled water (5 mL×5) and acetone (5 mL×5) and then dried under vacuum to give the trimethylammonium methanesulfonate polystyrene (1-1, 235 mg).

### Example 6

### Preparation of Triethylammonium Methanesulfonate Polystyrene (1-2)

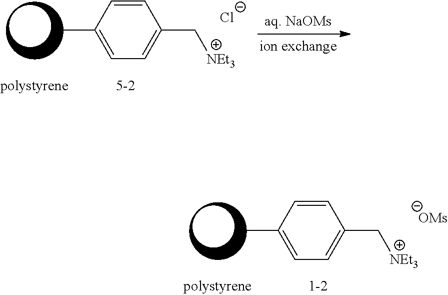

From polymer 5-2 (100-200 mesh, 200 mg), triethylammonium methanesulfonate polystyrene (1-2, 222 mg) was prepared by following the same procedure as example 5.

### Example 7

### Preparation of N-Methylimidazolium Methanesulfonate Polystyrene (1-3)

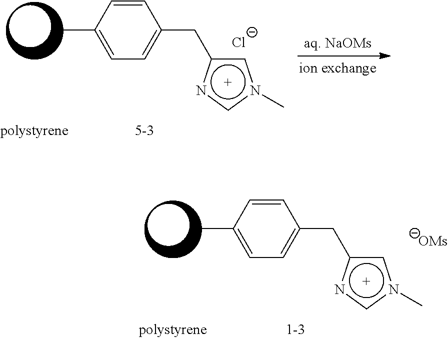

From polymer 5-3 00-200 mesh, 200 mg), N-methylimidazolium methanesulfonate polystyrene (1-3, 225 mg) was prepared by following the same procedure as example 5.

### Example 8

### Preparation of Pyridinium Methanesulfonate Polystyrene (1-4)

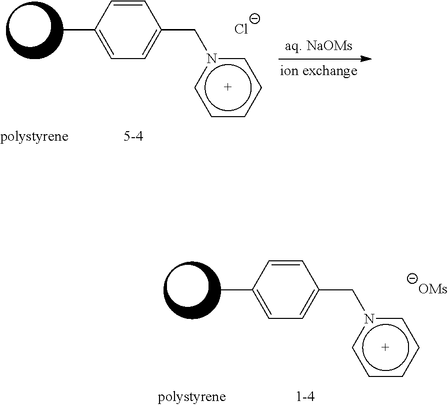

From polymer 5-4 (100-200 mesh, 200 mg), N-methylimidazolium methanesulfonate polystyrene (1-4, 220 mg) was prepared by following the same procedure as example 5.

TABLE 2

| compound | tertiary amine | calculated (mmol/g) |
|---|---|---|
| 1-1 | NMe₃ | 1.813 |
| 1-2 | NEt₃ | 1.823 |
| 1-3 | N-methyl imidazole | 1.805 |
| 1-4 | pyridine | 1.817 |

### Example 9

### Preparation of Polymer Cartridge Containing Neutral Ammonium Polystyrene

The neutral ammonium methanesulfonate polymers 1 ranging from 20 mg to 100 mg were filled into a cartridge equipped with a polyethylene frit.

Polymer cartridge 6-1 were prepared by being filled with polymer 1-1
Polymer cartridge 6-2 were prepared by being filled with polymer 1-2
Polymer cartridge 6-3 were prepared by being filled with polymer 1-3
Polymer cartridge 6-4 were prepared by being filled with polymer 1-4

### Example 10

### Preparation of Eluting Solution

The eluting solutions for releasing [¹⁸F]fluoride captured in a cartridge were prepared by composing three ingredients, and dissolved in alcohol solvent.

### Ingredient A: Kryptofix 2,2,2 (K222); 10 20 mg

Ingredient B: 0.05-0.2 M KOMs, KOTf, K₃PO₄ in water; 0.05-0.2 mL

### Ingredient C: TBAHCO₃ (1-20 μL), TBAOH (1-20 μL), or 0.05-0.2 M KOH, K₂CO₃, or KHCO₃; 0.01-0.2 mL

Each ingredient was selected from each group A, B. and C. and mixed together to make several eluting solutions as follows;

### Eluent A

### 1) Kryptofix 2,2,2 (K222); 10-20 mg

2) 0.2 M KOMs in water; 0.05-0.2 mL

### 3) TBAHCO₃; 1-20 μL

4) alcohol; 1 mL

### Eluent B

### 1) Kryptofix 2,2,2 (K222); 10-20 mg

2) 0.2 M KOTf in water; 0.05-0.2 mL

### 3) TBAHCO₃; 1-20 μL

4) alcohol; 1 mL

### Eluent C

### 1) Kryptofix 2.22(K₂₂₂); 10-20 mg

2) 0.2 M K₃PO₄ in water; 0.05-0.2 mL

### 3) TBAHCO₃; 1-20 μL

4) alcohol; 1 mL

### Eluent D

### 1) Kryptofix 2,2,2(K222); 10-20 mg

2) 0.2 M KOMs in water; 0.05-0.2 mL

### 3) TBAOH; 1-20 μL

4) alcohol; 1 mL

### Eluent E

### 1) Kryptofix 2,2,2 (K222); 10-20 mg

2) 0.2 M KOMs in water; 0.05-0.2 mL
3) 0.05-0.2 M KOH in water; 0.01-0.2 mL
4) alcohol; 1 mL

### Eluent F

### 1) Kryptofix 2,2,2 (K222); 10-20 mg

2) 0.2 M KOMs in water; 0.05-0.2 mL
3) 0.05-0.2 M K₂CO₃ in water; 0.01-0.2 mL
4) alcohol; 1 mL

### Eluent G

### 1) Kryptofix 2,2,2 (K222); 10-20 mg

2) 0.2 M KOMs in water; 0.05-0.2 mL
3) 0.05-0.2 M KHCO₃ in water; 0.01-0.2 mL
4) alcohol; 1 mL

### Example 11

### Eluting test of [¹⁸]fluoride Trapped in the Cartridges Using Alcoholic Eluting Solution (Eluent A)

Dilute aqueous [^{18]fluoride solution (ca.} 3-6 mCi) was passed through the cartridges (6-1-6-4) prepared by present invention to trap [¹⁸F]fluoride. The [¹⁸F]fluoride-trapped cartridge was then washed with distilled water (1.0 mL) and methanol solvent (1.0 mL) in sequence. [¹⁸F]Fluoride trapped in the cartridge was released by eluting the solution (Eluent A) prepared in the present invention. The released amount of [¹⁸F]fluoride from the cartridge was counted every 0.1 mL elution. The result of elution using present invention is summarized in Table 3.

TABLE 3
unit: mCi

| | | | | 6-3 | |
|---|---|---|---|---|---|
| | polymer catridge | 6-1 | 6-2 | N-methyl | 6-4 |
| step | tertiary amine | NMe₃ | NEt₃ | imidazole | pyridine |
| 1 | trapped | 4.87 | 5.15 | 4.59 | 3.52 |
| 2 | water (1.0 mL) | 0 | 0 | 0.01 | 0.05 |
| 3 | methanol (1.0 mL) | 0 | 0 | 0.01 | 0.03 |
| 4 | 0.1 mL | 0.40 | 1.23 | 0.98 | 0.73 |
| 5 | 0.2 mL | 1.42 | 3.11 | 1.67 | 1.84 |
| 6 | 0.3 mL | 2.90 | 4.03 | 2.72 | 2.71 |
| 7 | 0.4 mL | 3.86 | 4.56 | 3.33 | 3.05 |
| 8 | 0.5 mL | 4.33 | 4.8 | 3.81 | 3.22 |
| 9 | 0.6 mL | 4.54 | 4.92 | 4.10 | 3.29 |
| 10 | 0.7 mL | 4.64 | 4.95 | 4.23 | 3.31 |
| 11 | 0.8 mL | 4.68 | 4.97 | 4.30 | 3.33 |
| 12 | 0.9 mL | 4.70 | 4.97 | 4.36 | 3.33 |
| 13 | 1.0 mL | 4.71 | 4.97 | 4.38 | 3.33 |
| 14 | Cartridge | 0 | 0 | 0 | 0 |

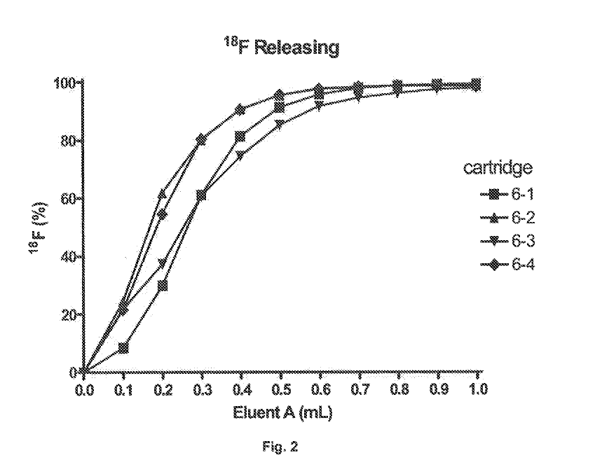

Respective steps were described as follows;
Step 1—remained radioactivity in the cartridge after eluting [¹⁸F]fluoride solution through the said cartridge. (in all cases, no radioactivity were detected in filtrate solution)
Step 2—released radioactivity out of the cartridge after washing with distilled water (1.0 mL)
Step 3—released radioactivity out of the cartridge after washing with methanol (1.0 mL)
Step 4-13—released radioactivity out of the cartridge after eluting with every 0.1 mL of alcoholic eluenting solution prepared in present invention.
Step 14—remained radioactivity in the cartridge after step 13.
This result of eluting test was illustrated in FIG. 2.

### Example 12

### Eluting Test of [F]fluoride Trapped in the Cartridge 6-3 Using Alcoholic Eluting Solutions (Eluent A-Eluent C)

TABLE 4
unit: %

| step | Eluent | A (KOMs) | B (KOTf) | C (K₃PO₄) |
|---|---|---|---|---|
| 1 | trapped | 100 | 100 | 100 |
| 2 | water (1.0 mL) | 0 | 0 | 0 |
| 3 | methanol (1.0 mL) | 0 | 0 | 0 |
| 4 | 0.1 mL | 3.4 | 4.8 | 4.8 |
| 5 | 0.2 mL | 52.7 | 43.7 | 50.8 |
| 6 | 0.3 mL | 86.7 | 84.6 | 83.6 |
| 7 | 0.4 mL | 96.2 | 96.99 | 94.2 |
| 8 | 0.5 mL | 98.5 | 98.9 | 97.4 |
| 9 | cartridge | 0 | 0 | 0 |

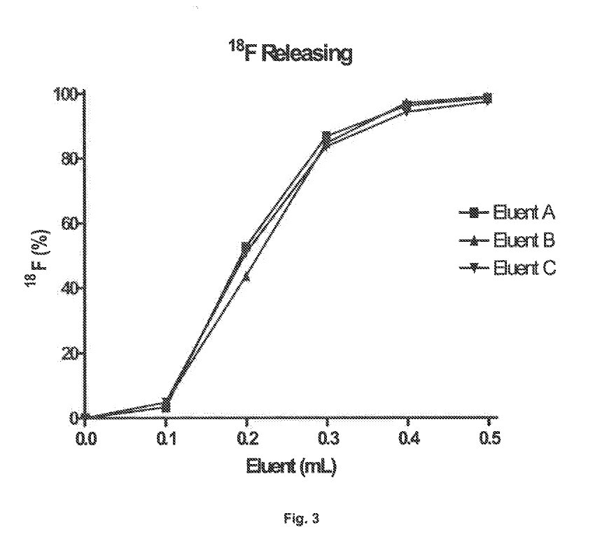

Respective steps were described as follows;
Step 1—remained radioactivity (100%) in the cartridge after eluting [¹⁸F]fluoride solution through the said cartridge. (in all cases, no radioactivity were detected in filtrate solution)
Step 2—released radioactivity (%) out of the cartridge after washing with distilled water (1.0 mL)
Step 3—released radioactivity (%) out of the cartridge after washing with methanol (1.0 mL)
Step 4-8—released radioactivity (%) out of the cartridge after eluting with every 0.1 mL of alcoholic eluenting solution prepared in present invention.
Step 9—remained radioactivity (%) in the cartridge after step 8.
This result of eluting test was illustrated in FIG. 3.

### Example 13

### Fluorination of 2-[¹⁸F]fluoro-Deoxyglucose ([¹⁸F]FDG) Precursor Using Present Invention

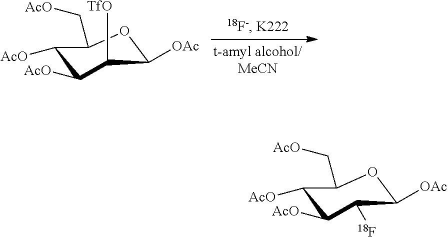

Aqueous [¹⁸F]fluoride solution was passed through the cartridge (6-3) of the present invention. No [¹⁸F]fluoride was detected in the filtrate solution and 92.1-115.4 MBq of [¹⁸F]fluoride was trapped in the cartridge. The trapped [¹⁸F]fluoride was eluted with the Eluent (A, B, or C) solution of the present invention into a reaction vial, Remained radioactivity in the cartridge was 1.85˜2.96 MBq. The eluted solution was heated at 100° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (5 mg) dissolved in a co-solvent of t-amyl alcohol (1.0 mL) and acetonitrile (0.1 mL) was added to the reaction vial. The reaction mixture was heated at 100° C. for 10 min, and then cooled to room temperature. Radio-TLC scanning showed 90.9% of radiolabeling.

| Eluent | precursor | 5 min | 10 min |
|---|---|---|---|
| A | 5 mg | 97.4 | 87.0 |
| B | 5 mg | 96.0 | 90.9 |
| C | 5 mg | 90.6 | 88.3 |

### Example 14

### Preparation of [¹⁸F]FP-CIT Using Present Invention

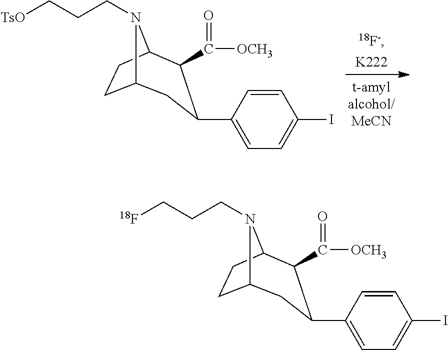 [SMILES: COC(=O)[C@H]1C(c2ccc(I)cc2)CC2CCC1N2CCCOS(=O)(=O)c1ccc(C)cc1 ; COC(=O)[C@H]1C(c2ccc(I)cc2)CC2CCC1N2CCC[18F]]

Aqueous [¹⁸F]fluoride solution was passed through the cartridge (6-3) of the present invention, No [¹⁸F]fluoride was detected in the filtrate solution and 195.4 MBq of [¹⁸F]fluoride was trapped in the cartridge. The trapped [¹⁸F]fluoride was eluted with the Eluent A solution of the present invention into a reaction vial. Remained radioactivity in the cartridge was 11.47 MBq. The eluted solution was heated at 100° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (4 mg) dissolved in a co-solvent of t-amyl alcohol (1.0 mL) and acetonitrile (0.05 mL) was added to the reaction vial. The reaction mixture was heated at 100° C. for 20 min, and then cooled to room temperature. Radio-TLC scanning showed 86.8% of radiolabeling. HPLC purification (Varian, Bondclon C18 column 250 mm×10 mm, H₂O: EtOH:Et₃N=250:750:2, 4 mL/min, at 229 nm) was performed to give [¹⁸]FP-CIT in 67.9% of radiochemical yield (RCY, decay-corrected). Total preparation including HPLC purification spent 50 min.

### Example 15

### Preparation of [¹⁸F]FP-CIT Using Present Invention

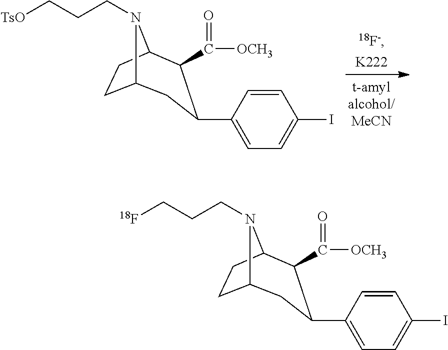 [SMILES: COC(=O)[C@H]1C(c2ccc(I)cc2)CC2CCC1N2CCCOS(=O)(=O)c1ccc(C)cc1 ; COC(=O)[C@H]1C(c2ccc(I)cc2)CC2CCC1N2CCC[18F]]

Aqueous [¹⁸F]fluoride solution was passed through the cartridge (6-3) of the present invention. No [¹⁸F]fluoride was detected in the filtrate solution and 356.3 MBq of [¹⁸F]fluoride was trapped in the cartridge. The trapped [¹⁸F]fluoride was eluted with the Eluent D solution of the present invention into a reaction vial. Remained radioactivity in the cartridge was 54.8 MBq. The eluted solution was heated at 100° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (4 mg) dissolved in a co-solvent of t-amyl alcohol (1.0 mL) and acetonitrile (0.05 mL) was added to the reaction vial. The reaction mixture was heated at 120° C. for 20 min, and then cooled to room temperature. Radio-TLC scanning showed 52.2% of radiolabeling. HPLC purification was performed to give [¹⁸F]FP-CIT in 42.4% of radiochemical yield (RCY, decay-corrected). Total preparation including HPLC purification spent. 50 min.

### Example 16

### Preparation of [¹⁸F]FP-CIT Using Present Invention

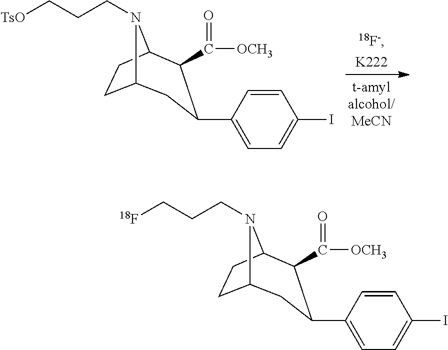 [SMILES: COC(=O)[C@H]1C(c2ccc(I)cc2)CC2CCC1N2CCCOS(=O)(=O)c1ccc(C)cc1 ; COC(=O)[C@H]1C(c2ccc(I)cc2)CC2CCC1N2CCC[18F]]

Aqueous [¹⁸F]fluoride solution was passed through the cartridge (6-3) of the present invention. No [¹⁸F]fluoride was detected in the filtrate solution and 207.9 MBq of [¹⁸F]fluoride was trapped in the cartridge. The trapped [¹⁸F]fluoride was eluted with the Eluent E solution of the present invention into a reaction vial. Remained radioactivity in the cartridge was 9.25 MBq. The eluted solution was heated at 100° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (4 mg) dissolved in a co-solvent of t-amyl alcohol (1.0 mL) and acetonitrile (0.05 mL) was added to the reaction vial. The reaction mixture was heated at 100° C. for 20 min, and then cooled to room temperature. Radio-TLC scanning showed 95.1% of radiolabeling. HPLC purification was performed to give [¹⁸F]FP-CIT in 49.5% of radiochemical yield (RCY, decay-corrected). Total preparation including HPLC purification spent 51 min.

### Example 17

### Preparation of [¹⁸F]FP-CIT Using Present Invention

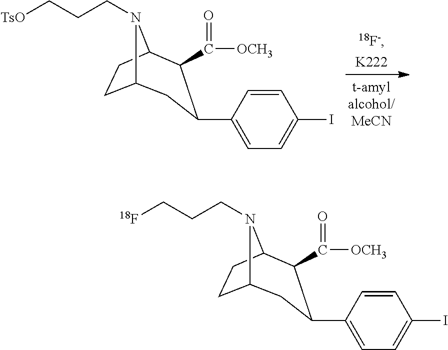 [SMILES: COC(=O)[C@H]1C(c2ccc(I)cc2)CC2CCC1N2CCCOS(=O)(=O)c1ccc(C)cc1 ; COC(=O)[C@H]1C(c2ccc(I)cc2)CC2CCC1N2CCC[18F]]

Aqueous [¹⁸F]fluoride solution was passed through the cartridge (6-3) of the present invention. No [¹⁸F]fluoride was detected in the filtrate solution and 147.9 MBq of [¹⁸F]fluoride was trapped in the cartridge. The trapped [¹⁸F]fluoride was eluted with the Eluent F solution of the present invention into a reaction vial. Remained radioactivity in the cartridge was 1.25 MBq. The eluted solution was heated at 100° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (4 mg) dissolved in a co-solvent of t-amyl alcohol (1.0 mL) and acetonitrile (0.05 mL) was added to the reaction vial. The reaction mixture was heated at 100° C. for 20 min, and then cooled to room temperature. Radio-TLC scanning showed 53.6% of radiolabeling.

### Example 18

### Preparation of 2-[¹⁸F]fluoro-Deoxyglucose ([¹⁸F]FDG) Using Present Invention

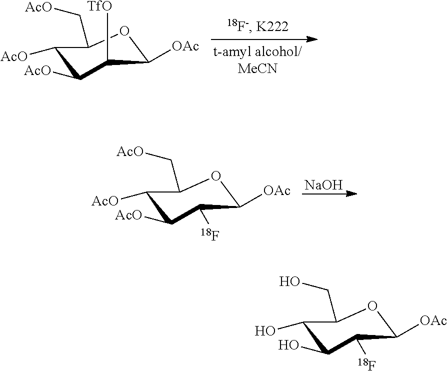

Aqueous [¹⁸F]fluoride solution was passed through the cartridge (6-3) of the present invention. No [¹⁸F]fluoride was detected in the filtrate solution and 214.49 MBq of [¹⁸F]fluoride was trapped in the cartridge. The trapped [¹⁸F]fluoride was eluted with the Eluent A solution of the present invention into a reaction vial. Remained radioactivity in the cartridge was 61.5 MBq. The eluted solution was heated at 100° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (20 mg) dissolved in a co-solvent. of t-amyl alcohol (1.0 mL) and acetonitrile (0.1 mL) was added to the reaction vial. The reaction mixture was heated at 100° C. for 20 min, and then cooled to room temperature. Radio-TLC scanning showed 92.8% of radiolabeling. The solvent was removed by N₂ purging under heat. at 100° C. The residue was dissolved in acetonitrile (0.5 mL), and than diluted with water (20 mL). The diluted solution was passed through a C18 SepPak cartridge, which and then filled with 2 M aqueous NaOH solution (1 mL), and left for 2 min at room temperature for hydrolysis. The reaction mixture was passed through IC-H cartridge and almunia N SepPak cartridge in sequence to give 2-[¹⁸F]fluoro-deoxyglucose ([¹⁸F]FDG) in 61.9% of RCY (decay-corrected). Total preparation including HPLC purification spent 50 min.

### Example 19

### Preparation of 2-[¹⁸F]-fluoro-deoxyglucose ([¹⁸F]FDG) Using Present Invention

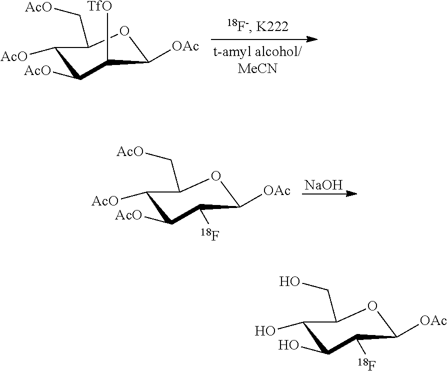

Aqueous [¹⁸F]fluoride solution was passed through the cartridge (6-3) of the present invention. No [¹⁸F]fluoride was detected in the filtrate solution and 148.0 MBq of [¹⁸F]fluoride was trapped in the cartridge. The trapped [¹⁸F]fluoride was eluted with the Eluent E solution of the present invention into a reaction vial. Remained radioactivity in the cartridge was 9.25 MBq. The eluted solution was heated at 100° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (5 mg) dissolved in a co-solvent of t-amyl alcohol (1.0 mL) and acetonitrile (0.1 mL) was added to the reaction vial. The reaction mixture was heated at 120° C. for 10 min, and then cooled to room temperature. Radio-TLC scanning showed 77.7% of radiolabeling. The solvent was removed by N₂ purging under heat at 100′C. The residue was dissolved in acetonitrile (0.5 mL), and then diluted with water (20 mL). The diluted solution was passed through a C18 SepPak cartridge, which and then filled with 2 M aqueous NaOH solution (1 mL), and left for 2 min at room temperature for hydrolysis. The reaction mixture was passed through IC-H cartridge and almunia N SepPak cartridge in sequence to give 2-[¹⁸F]fluoro-deoxyglucose ([¹⁸F]FDG) in 48.9% of RCY (decay-corrected). Total preparation including HPLC purification spent 42 min.

### Example 20

### Preparation of [¹⁸F]fluorothymidine ([¹⁸F]FLT) Using Present Invention

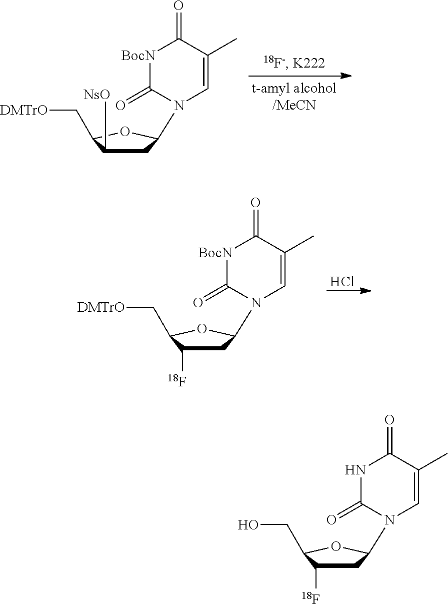

Aqueous [¹⁸F]fluoride solution was passed through the cartridge (6-3) of the present invention. No [¹⁸F]fluoride was detected in the filtrate solution and 192.3 MBq of [¹⁸F]fluoride was trapped in the cartridge. The trapped [¹⁸F]fluoride was eluted with the Eluent A solution of the present invention to a reaction vial. Remained radioactivity in the cartridge was 15.2 MBq. The eluted solution was heated at 120° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (20 mg) dissolved in a co-solvent of t-amyl alcohol (1.0 mL) and acetonitrile (0.1 mL) was added to the reaction vial. The reaction mixture was heated at 120° C. for 20 min, and then cooled to room temperature. Radio-TLC scanning showed 93.3% of radiolabeling. The solvent was removed by N₂ purging under heat at 100° C. The residue was dissolved in acetonitrile (0.1 mL) and diluted with 1 M HCl aqueous solution (0.5 mL). The solution was heated at 85° C. for 5 min, and then treated with 2 M NaOH aqueous solution (0.25 mL). HPLC purification (TSP, Econosil C18 column 250 mm×10 mm, H₂O:EtOH=90:10, 5 mL/min. at 267 nm) was performed to give [¹⁸F]FLT in 48.6% of radiochemical yield (RCY, decay-corrected). Total preparation including HPLC purification spent 55 min.

### Example 21

### Preparation of [¹⁸F]fluorothymidine ([¹⁸]FLT) Using Present Invention

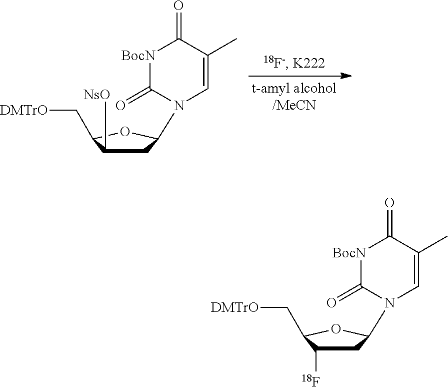

Aqueous [¹⁸F]fluoride solution was passed through the cartridge (6-3) of the present invention. No [¹⁸F]fluoride was detected in the filtrate solution and 212.7 MBq of [¹⁸F]fluoride was trapped in the cartridge. The trapped [¹⁸F]fluoride was eluted with the Eluent E solution of the present invention to a reaction vial. Remained radioactivity in the cartridge was 16.3 MBq. The eluted solution was heated at 120° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (20 mg) dissolved in a co-solvent of t-amyl alcohol (1.0 mL) and acetonitrile (0.1 mL) was added to the reaction vial, The reaction mixture was heated at 100° C. for 10 min, and then cooled to room temperature. Radio-TLC scanning showed 74.8% of radiolabeling.

### Example 22

### Preparation of [¹⁸F]fluorothymidine ([¹⁸]FLT) Using Present Invention

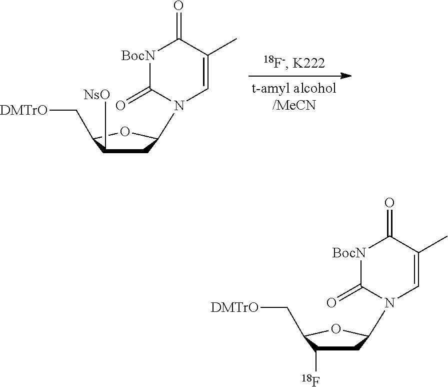

Aqueous [¹⁸F]fluoride solution was passed through the cartridge (6-3) of the present invention. No [¹⁸F]fluoride was detected in the filtrate solution and 375.1 MBq of [¹⁸F]fluoride was trapped in the cartridge. The trapped [¹⁸F]fluoride was eluted with the Eluent G solution of the present invention to a reaction vial. Remained radioactivity in the cartridge was 27.9 MBq. The eluted solution was heated at 120° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (10 mg) dissolved in a co-solvent of t-amyl alcohol (1.0 mL) and acetonitrile (0.1 mL) was added to the reaction vial. The reaction mixture was heated at 100° C. for 20 min, and then cooled to room temperature. Radio-TLC scanning showed 77.5% of radiolabeling.

### Example 23

### Preparation of [¹⁸F]fluoromisonidazole ([¹⁸F]FMISO) Using Present Invention

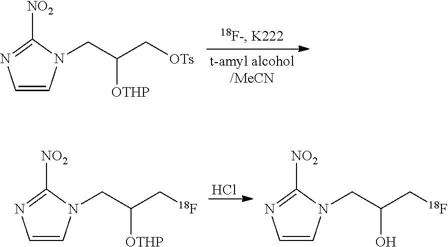

Aqueous [¹⁸F]fluoride solution was passed through the cartridge (6-3) of the present invention. No [¹⁸F]fluoride was detected in the filtrate solution and 145.9 MBq of [¹⁸F]fluoride was trapped in the cartridge. The trapped [¹⁸F]fluoride was eluted with the Eluent A solution of the present invention to a reaction vial. Remained radioactivity in the cartridge was 12.4 MBq. The eluted solution was heated at 120° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (10 mg) dissolved in a co-solvent of t-amyl alcohol (1.0 mL) and acetonitrile (0.1 mL) was added to the reaction vial. The reaction mixture was heated at 120° C. for 10 min, and then cooled to room temperature. Radio-TLC scanning showed 96.1% of radiolabeling. The solvent was removed by N₂ purging under heat at 100° C. The residue was dissolved in acetonitrile (0.1 mL) and diluted with 1 M HCl aqueous solution (0.5 mL). The solution was heated at 85° C. for 5 min, and then treated with 2 M NaOH aqueous solution (0.25 mL). HPLC purification (TSP, Econosil C18 column 250 mm×10 mm H₂O:EtOH=95:5, 5 mL/min, at 254 nm) was performed to give [¹⁸]FMISO in 42.3% of radiochemical yield (RCY, decay-corrected). Total preparation including HPLC purification spent 45 min.

### Example 24

### Preparation of [¹⁸F]BAY94-9172 Using Present Invention

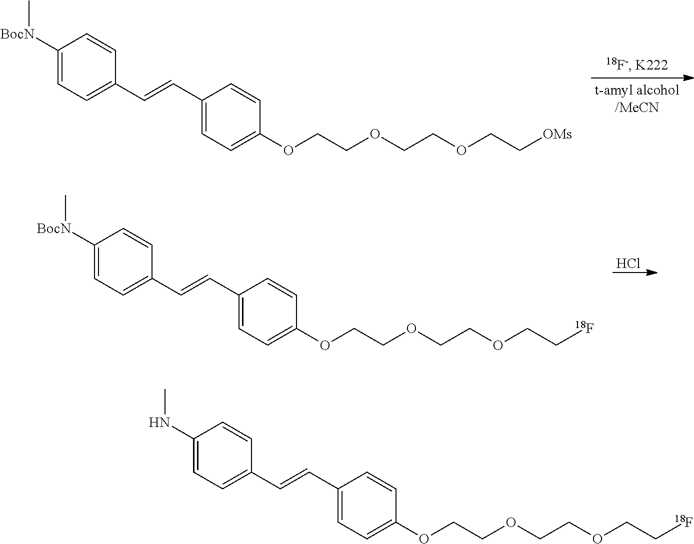 [SMILES: CN(C(=O)OC(C)(C)C)c1ccc(/C=C/c2ccc(OCCOCCOCCOS(C)(=O)=O)cc2)cc1 ; CN(C(=O)OC(C)(C)C)c1ccc(/C=C/c2ccc(OCCOCCOCC[18F])cc2)cc1 ; Cl ; CNc1ccc(/C=C/c2ccc(OCCOCCOCC[18F])cc2)cc1]

Aqueous [¹⁸F]fluoride solution was passed through the cartridge (6-3) of the present invention. No [¹⁸F]fluoride was detected in the filtrate solution and 294.2 MBq of [¹⁸F]fluoride was trapped in the cartridge. The trapped [¹⁸F]fluoride was eluted with the Eluent A solution of the present invention to a reaction vial. Remained radioactivity in the cartridge was 35.5 MBq. The eluted solution was heated at 120° C. with a gentle flow of N₂ gas to remove volatile solvent, and then acetonitrile (0.5 mL) was added to the reaction vial, Azeotropic evaporation was repeated. Complete removal of solvent including water took in a range from 1 min and 30 seconds to 2 min. A solution of precursor (4 mg) dissolved in a co-solvent of t-amyl alcohol (1.0 mL) and acetonitrile (0.1 mL) was added to the reaction vial. The reaction mixture was heated at 120° C. for 10 min, and then cooled to room temperature. Radio-TLC scanning showed 81.1% of radiolabeling. The solvent was removed by N₂ purging under heat at 120° C. The residue was dissolved in acetonitrile (0.3 mL) and diluted with 1 M HCl aqueous solution (0.5 mL). The solution was heated at 120° C. for 5 min, and then treated with 2 M NaOH aqueous solution (0.25 mL), HPLC purification (Varian, Gemini C18 column 250 mm×10 mm 0.1 M ammonium formate:MeCN=40:60, 4 mL/min, at 254 nm) was performed to give [¹⁸F]BAY94-9172 in 58.1% of radiochemical yield (RCY, decay-corrected). Total preparation including HPLC purification spent 60 min.

### Example 25

### Preparation of [¹⁸]BAY94-9172 Using Present Invention

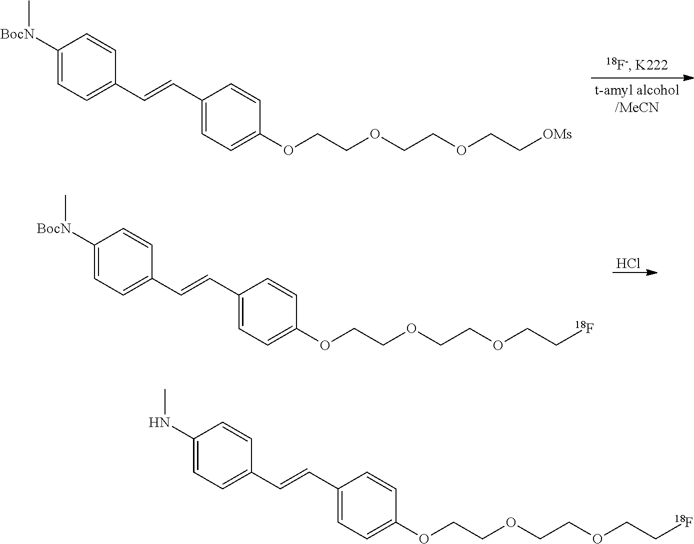 [SMILES: CN(C(=O)OC(C)(C)C)c1ccc(/C=C/c2ccc(OCCOCCOCCOS(C)(=O)=O)cc2)cc1 ; CN(C(=O)OC(C)(C)C)c1ccc(/C=C/c2ccc(OCCOCCOCC[18F])cc2)cc1 ; Cl ; CNc1ccc(/C=C/c2ccc(OCCOCCOCC[18F])cc2)cc1]

Aqueous [¹⁸F]fluoride solution was passed through the cartridge (6-3) of the present invention. No [¹⁸F]fluoride was detected in the filtrate solution and 154.3 MBq of [¹⁸F]fluoride was trapped in the cartridge. The trapped [¹⁸F]fluoride was eluted with the Eluent D solution of the present invention to a reaction vial. Remained radioactivity in the cartridge was 13.0 MBq. The eluted solution was heated at 120° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (4 mg) dissolved in a co-solvent of t-amyl alcohol (1.0 mL) and acetonitrile (0.1 mL) was added to the reaction vial. The reaction mixture was heated at 120° C. for 20 min, and then cooled to room temperature. Radio-TLC scanning showed 86.91% of radiolabeling. The solvent was removed by N₂ purging under heat at 120° C. The residue was dissolved in acetonitrile (0.3 mL) and diluted with 1 M HCl aqueous solution (0.5 mL). The solution was heated at 120° C. for 5 min, and then treated with 2 M NaOH aqueous solution (0.25 mL). HPLC purification (Varian, Gemini C18 column 250 mm×10 mm 0.1 M ammonium formate:MeCN=40:60, 4 mL/min. at 254 nm) was performed to give [¹⁸F]BAY94-9172 in 68.9% of radiochemical yield (RCY, decay-corrected). Total preparation including HPLC purification spent 60 min.

### Example 26

### Preparation of [¹⁸]BAY94-9172 Using Present Invention

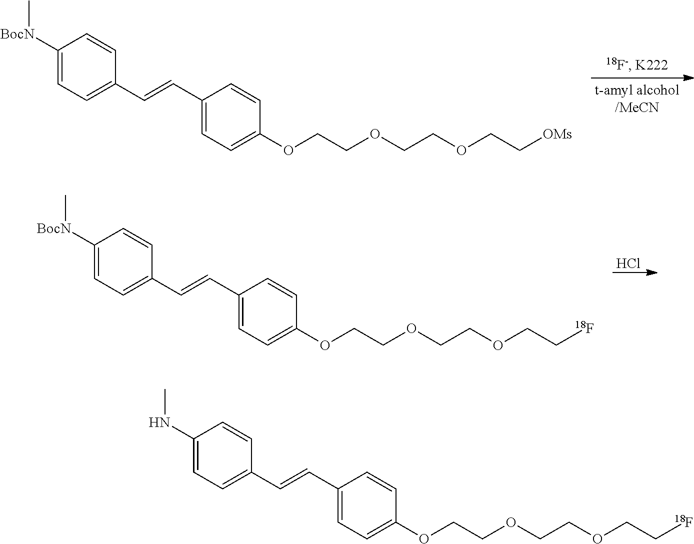 [SMILES: CN(C(=O)OC(C)(C)C)c1ccc(/C=C/c2ccc(OCCOCCOCCOS(C)(=O)=O)cc2)cc1 ; CN(C(=O)OC(C)(C)C)c1ccc(/C=C/c2ccc(OCCOCCOCC[18F])cc2)cc1 ; Cl ; CNc1ccc(/C=C/c2ccc(OCCOCCOCC[18F])cc2)cc1]

Aqueous [¹⁸F]fluoride solution was passed through the cartridge (6-3) of the present invention. No [¹⁸F]fluoride was detected in the filtrate solution and 173.2 MBq of [¹⁸F]fluoride was trapped in the cartridge. The trapped [¹⁸F]fluoride was eluted with the Eluent G solution of the present invention to a reaction vial. Remained radioactivity in the cartridge was 1.48 MBq. The eluted solution was heated at 120° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (4 mg) dissolved in a co-solvent of t-amyl alcohol (1.0 mL) and acetonitrile (0.1 mL) was added to the reaction vial. The reaction mixture was heated at 120° C. for 20 min, and then cooled to room temperature. Radio-TLC scanning showed 86.9% of radiolabeling. The solvent was removed by N₂ purging under heat at 120° C. The residue was dissolved in acetonitrile (0.3 mL) and diluted with 1 M HCl aqueous solution (0.5 mL). The solution was heated at 120° C. for 5 min, and then treated with 2 M NaOH aqueous solution (0.25 mL). HPLC purification was performed to give [¹⁸]BAY94-9172 in 52.2% of radiochemical yield (RCY, decay-corrected). Total preparation including HPLC purification spent 60 min.

### Example 27

### Preparation of [¹⁸F]FDDNP Using Present Invention

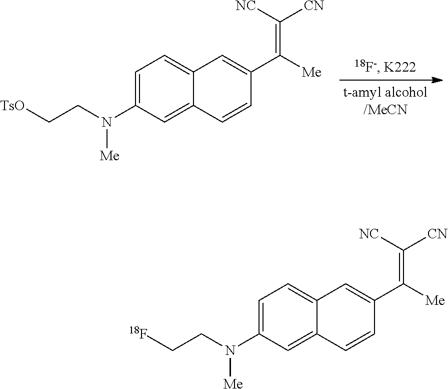 [SMILES: CC(=C(C#N)C#N)c1ccc2cc(N(C)CCOS(=O)(=O)c3ccc(C)cc3)ccc2c1 ; CC(=C(C#N)C#N)c1ccc2cc(N(C)CC[18F])ccc2c1]

Aqueous [¹⁸F]fluoride solution was passed through the cartridge (6-3) of the present invention. No [¹⁸F]fluoride was detected in the filtrate solution and 330.8 GBq of [¹⁸F]fluoride was trapped in the cartridge. The trapped [¹⁸F]fluoride was eluted with the Eluent A solution of the present invention to a reaction vial. Remained radioactivity in the cartridge was 43.3 MBq. The eluted solution was heated at 120° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (2 mg) dissolved in a co-solvent of t-amyl alcohol (1.0 mL) and acetonitrile (0.1 mL) was added to the reaction vial. The reaction mixture was heated at 100° C. for 5 min, and than cooled to room temperature. Radio-TLC scanning showed 92.4% of radiolabeling. HPLC purification (Varian, Econosil C18 column 250 mm×10 mm 50 mM triethylammonium phosphate:MeCN=40:60, 4 mL/min, at 254 nm) was performed to give [¹⁸F]FDDNP in 48.5% of radiochemical yield (ROY, decay-corrected). Total preparation including HPLC purification spent 61 min.

### Example 28

### Preparation of [¹⁸F]FDDNP Using Present Invention

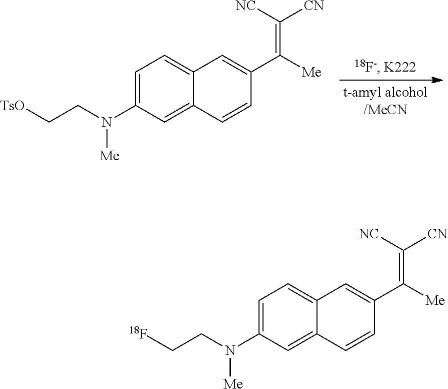 [SMILES: CC(=C(C#N)C#N)c1ccc2cc(N(C)CCOS(=O)(=O)c3ccc(C)cc3)ccc2c1 ; CC(=C(C#N)C#N)c1ccc2cc(N(C)CC[18F])ccc2c1]

Aqueous [¹⁸F]fluoride solution was passed through the cartridge (6-3) of the present invention. No [¹⁸F]fluoride was detected in the filtrate solution and 259.8 GBq of [¹⁸F]fluoride was trapped in the cartridge, The trapped [¹⁸F]fluoride was eluted with the Eluent F solution of the present invention to a reaction vial. Remained radioactivity in the cartridge was 23.3 MBq. The eluted solution was heated at 120° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (2 mg) dissolved in a co-solvent of t-amyl alcohol (1.0 mL) and acetonitrile (0.1 mL) was added to the reaction vial. The reaction mixture was heated at 100° C. for 5 min, and then cooled to room temperature. Radio-TLC scanning showed 85.1% of radiolabeling. HPLC purification (Varian. Econosil 018 column 250 mm×10 mm 50 mM triethylammonium phosphate:MeCN=40:60, 4 mL/min, at 254 nm) was performed to give [¹⁸F]FDDNP in 48.5% of radiochemical yield (RCY, decay-corrected). Total preparation including HPLC purification spent 61 min.

### Example 29

### Preparation of [¹⁸F]FDDNP Using Present Invention

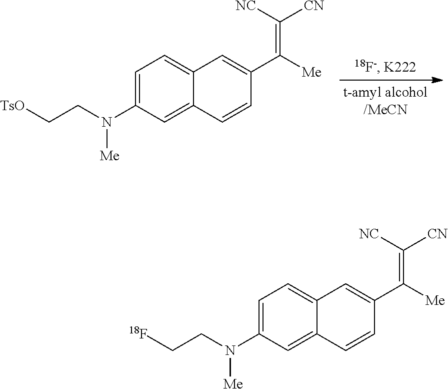 [SMILES: CC(=C(C#N)C#N)c1ccc2cc(N(C)CCOS(=O)(=O)c3ccc(C)cc3)ccc2c1 ; CC(=C(C#N)C#N)c1ccc2cc(N(C)CC[18F])ccc2c1]

Aqueous [¹⁸F]fluoride solution was passed through the cartridge (6-3) of the present invention, No [¹⁸F]fluoride was detected in the filtrate solution and 210.7 GBq of [¹⁸F]fluoride was trapped in the cartridge. The trapped [¹⁸F]fluoride was eluted with the Eluent G solution of the present invention to a reaction vial. Remained radioactivity in the cartridge was 16,3 MBq. The eluted solution was heated at 120° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (2 mg) dissolved in a co-solvent of t-amyl alcohol (1.0 mL) and acetonitrile (0.1 mL) was added to the reaction vial. The reaction mixture was heated at 100° C. for 5 min, and then cooled to room temperature. Radio-TLC scanning showed 95.9% radiolabeling (RCY, decay-corrected). Total preparation including HPLC purification spent 65 min.

### Example 30

### Preparation of [¹⁸F]AV-45 Using Present Invention

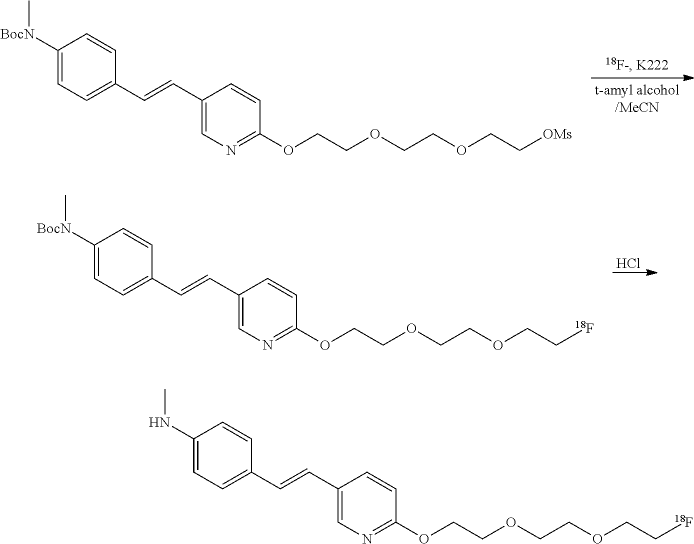 [SMILES: CN(C(=O)OC(C)(C)C)c1ccc(/C=C/c2ccc(OCCOCCOCCOS(C)(=O)=O)nc2)cc1 ; CN(C(=O)OC(C)(C)C)c1ccc(/C=C/c2ccc(OCCOCCOCC[18F])nc2)cc1 ; Cl ; CNc1ccc(/C=C/c2ccc(OCCOCCOCC[18F])nc2)cc1]

Aqueous [¹⁸F]fluoride solution was passed through the cartridge (6-3) of the present invention. No [¹⁸F]fluoride was detected in the filtrate solution and 2.49 GBq of [¹⁸F]fluoride was trapped in the cartridge. The trapped [¹⁸F]fluoride was eluted with the Eluent A solution of the present invention to a reaction vial. Remained radioactivity in the cartridge was 51.8 MBq. The eluted solution was heated at 120° C. with a gentle flow of N₂ gas to remove volatile solvent, and then acetonitrile (0.5 mL) was added to the reaction vial. Azeotropic evaporation was repeated. Complete removal of solvent including water took in a range from 1 min and 30 seconds to 2 min. A solution of precursor (4 mg) dissolved in a co-solvent of t-amyl alcohol (1.0 mL) and acetonitrile (0.1 mL) was added to the reaction vial. The reaction mixture was heated at 120° C. for 20 min, and then cooled to room temperature. Radio-TLC scanning showed 92.4% of radiolabeling. The solvent was removed by N2 purging under heat at 120° C. The residue was dissolved in acetonitrile (0.3 mL) and diluted with 1 M HCl aqueous solution (0.5 mL). The solution was heated at 120° C. for 5 min, and then treated with 2 M NaOH aqueous solution (0.25 mL). HPLC purification was performed to give [¹⁸]AV-45 in 59.4% of radiochemical yield (RCY, decay-corrected), Total preparation including HPLC purification spent 81 min.

In particular, the invention relates to:
1. A Processes to separate and elute [¹⁸F]fluoride, and rapid evaporation of [¹⁸F]fluoride solution, comprising the following steps:
   (a) Step 1—the preparation of quaternary ammonium polymers (Formula 1);
   (b) Step 2—the separation of [¹⁸F]fluoride ion using quaternary ammonium polymers (Formula 1) by solid-phase extraction;
   (c) Step 3—the preparation of alcoholic solutions consisted of K222, KOMs (or KOTf, or K₃PO₄), and TBAHCO₃(or TBAOH, or KOH, or K₂CO₃ or KHCO₃);
   (d) Step 4—the elution of [¹⁸F]fluoride ion trapped on the polymer of Step 1 with alcoholic solution of Step 3;
   (e) Step 5—the evaporation of the [¹⁸F]fluoride solution obtained in Step 4;
   (f) Step 6—the nucleophilic [¹⁸F]fluorination using the methods of Step 1-Step 5.
2. Quaternary Ammonium Polymers [Formula 1]

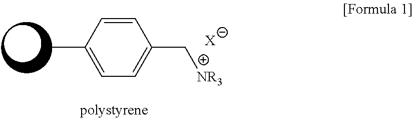

Wherein NR₃ is tertiary amine having C1-C4 alkyl chain; 5-membered or 6-membered heterocyclic compound having nitrogen atom;
X is inert alkylsulfonate or perfluoride ion having no nucleophilicity;
Polystyrene is the copolymer consisted of styrene, styrene derivatives, and divinylbenzene.
3. A process according to count 1, wherein the NR₃ is selected from the group consisting of trimethylamine, triethylamine, tri-n-propylamine, tri-n-butylamine. N-methylimidazole, and pyridine.
4. A process according to count 1 or 3, wherein the X is selected from the group consisting of methanesulfonate (OMs), trifluorornethanesulfonate (OTf), para-toluenesulfonate (OTs), para-nitrobenzenesulfonate (ONs), tetrafluoroborate (BF₄), hexafluorophosphate (PF₆), hexafluoroantimonate (SbF₆), and N,N-bis(trifluoromethanesulfonyl)amide (N(T)₂),
5. A Method for the preparation of neutral quaternary ammonium polymers.
6. A process according to daunt 5, wherein the quaternary ammonium polystyrenes having chloride anion are prepared in two synthetic ways as shown in Scheme 1.

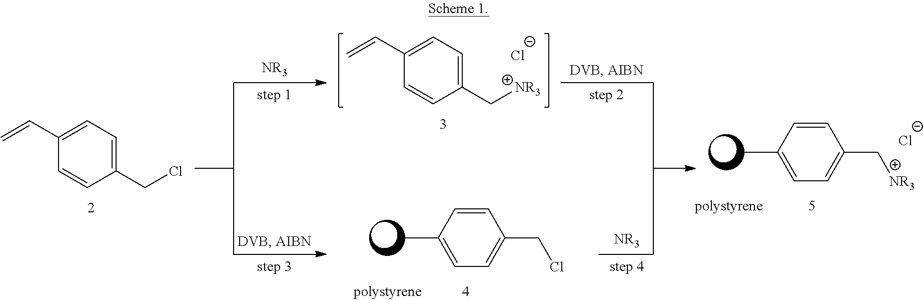

7. A process according to count 6, wherein 4-vinylbenzyl ammonium chloride (3) is synthesized by the reaction of 4-vinylbenzyl chloride and tertiary amine (step 1)
8. A process according to count 7, wherein the tertiary amine is selected from the group consisting of trimethylamine, triethylamine, tri-n-propylamine, tri-n-butylamine. N-methylimidazole, and pyridine.
9. A process according to count 6, wherein the ammonium chloride polystyrene (5) is synthesized by a radical polymerization of 4-vinylbenzyl ammonium chloride (3) and DVB initiated with AIBN (step 2).
10. A process according to count 6, wherein Merrifield-type chloromethyl polystyrene (formula 4) is synthesized by a radical polymerization of 4-vinylbenzyl chloride (2) and divinylbenzene initiated with AIBN (step 3).
11. A process according to the step 4 of count 6, wherein ammonium chloride polystyrene (5) is synthesized by quaternization of chloromethyl polystyrene (4) with a tertiary amine.
12. A process according to count 11, wherein tertiary amine is selected from the group consisted of trimethylamine, triethylamine, tri-n-propylamine, tri-n-butylamine, N-methylimidazole, and pyridine.
13. A process according to daunt 5, wherein the ammonium chloride polystyrene is sorted by using different sized sieves to give>50 mesh; 50-100 mesh; 100-200 mesh; 200-400 mesh; <400 mesh.
14. A method for the preparation of the quaternary ammonium polymers of the invention.
15. A process according to count 14, wherein the quaternary ammonium polymer (1) is prepared in anion exchange manner by repeating shaking/filtration of a suspension of ammonium chloride polymer (5) in aqueous MX solution as shown in Scheme 2.

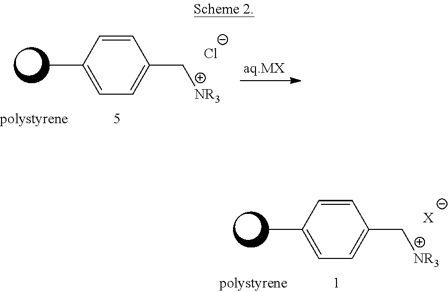

16. A process according to count 15, wherein M is selected from the group consisting of lithium (Li), sodium (Na), potassium (K), 1-n-butyl-3-methylimidazolium ([bmim]), pyridinium, substituted pyridinium, phosphonium, and NR₄ (R═Me, Et, n-Pr, n-Bu).
17. A process according to count 15, wherein X is selected from the group consisting of methanesulfonate (OMs), trifluoromethanesulfonate (OTf), para-toluenesulfonate (OTs), para-nitrobenzenesulfonate (ONs), tetrafluoroborate (BF₄), hexafluorophosphate (PF₆), hexafluoroantimonate (SbF₆), and N,N-bis(trifluoromethanesulfonyl)amide (N(Tf)₂).
18. A process according to daunt 15, wherein the aqueous solvent is selected from the group consisting of water or aqueous organic solvent of acetonitrile, methanol, ethanol, isopropanol, t-butanol, acetone, DMF, and DMSO.
19. A polymer cartridge 6 containing neutral ammonium polystyrene for solid-phase anion extraction.
20. A method for separation of [¹⁸F]fluoride from aqueous solution, wherein [¹⁸F]fluoride dissolved in aqueous solution is passed through the polymer cartridge of claim 19.
21. A method for the preparation of an eluting solution of the present invention.
22. A process according to count 21, wherein the eluting solution is prepared by composing three ingredients (Ingredient A, Ingredient B, and Ingredient C), and dissolved in an alcohol solvent.
23. A process according to count 21 and 22, wherein Ingredient A is K₂₂₂ that is used as a phase transfer catalyst of [¹⁸F]-fluorination in a range from 10 to 20 mg.
24. A process according to count 21 and 22, wherein Ingredient B comprises 0.05-0.2 M aqueous KOMs, KOTf, and K₃PO₄ that are used in a range from 0.05 to 0.2 mL.
25. A process according to count 21 and 22, wherein Ingredient C comprises TBAHCO₃ and TBAOH that are used in a range from 1 to 20 μL.
26. A process according to count 21 and 22, wherein Ingredient C also comprises 0.05-0.2 M aqueous KOH, K₂CO₃, and KHCO₃ that are used in a range from 0.01 to 0.2
27. A process according to count 21 and 22, wherein eluting solutions are prepared by composing and dissolving each component selected from each Ingredient group (Ingredient A, Ingredient B, and Ingredient C) in alcohol solvent.
28. A process according to count 21, 22, and 27, wherein alcohol solvent is selected from the group consisting of primary alcohol such as methanol, ethanol, n-propanol, n-butanol, n-pentanol, n-hexanol, n-heptanol, and n-octanol; or sencondary alcohol such as isopropanol, isobutanol, isoamyl alcohol, and 3-pentanol; or tertiary alcohol such as t-butanol, t-amyl alcohol, 2.3-dimethyl-2-butanol, 2-(trifluoromethyl)-2-propanol, 3-methyl-3-pentanol, 3-ethyl-3-pentanol, 2-emthyl-2-pentanol, 2,3-dimethyl-3-pentanol, 2,4-dimethyl-2-pentanol, 2-methyl-2-hexanol, 2-cyclopropyl-2-propanol, 2-cyclopropyl-2-butanol, 2-cyclopropyl-3′ methyl-2-butanol, 1-methylcyclopentanol, 1-ethylcyclopentanol, 1-propylcyclopentanol, 1-methylcyclohexanol, 1-ethylcyclohexanol, 1-methylcycloheptanol,
29. A process for releasing [¹⁸F]fluoride trapped in the polymer cartridge, wherein [¹⁸F]fluoride tramped in the polymer cartridge is washed with distilled water (0.5-5.0 mL) and alcohol (0.5-5.0 mL) in sequence, and then eluted with the eluting solution prepared according to claim 21.
30. A process according to count 29, wherein alcohol solvent is selected from the group consisting of primary alcohol such as methanol, ethanol, n-propanol, n-butanol, n-pentanol, n-hexanol, n-heptanol, and n-octanol; or sencondary alcohol such as isopropanol, isobutanol, isoamyl alcohol, and 3-pentanol; or tertiary alcohol such as t-butanol, t-amyl alcohol, 2,3-dimethyl-2-butanol, 2-(trifluoromethyl)-2-propanol, 3-methyl-3-pentanol, 3-ethyl-3-pentanol, 2-emthyl-2-pentanol, 2,3-dimethyl-3-pentanol, 2,4-dimethyl-2-pentanol, 2-methyl-2-hexanol, 2-cyclopropyl-2-propanol, 2-cyclopropyl-2-butanol, 2-cyclopropyl-3-methyl-2-butanol, 1-methylcyclopentanol, 1-ethylcyclopentanol, 1-propylcyclopentanol, 1-methylcyclohexanol, 1-ethylcyclohexanol, 1-methylcycloheptanol.
31. A process for evaporation of eluted solution containing [¹⁸F]fluoride, wherein eluted solution out of the polymer cartridge is heated at 60-120° C. with a gentle stream of N₂ or He gas and low vacuum for 1-3 min, and repeated after adding acetonitrile (0.5-1.0 mL) until all solvent including water is azeotropically removed entirely.
32. A process for nucleophilic [¹⁸F]fluorination, wherein nucleophilic [¹⁸F]fluorination is performed using the method of present invention.

1. A quaternary ammonium polymer of [Formula 1], 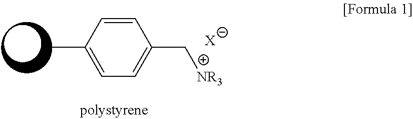
wherein NR₃ is a tertiary amine wherein R is a C1-C4 alkyl chain; or NR₃ is a 5-membered or 6-membered heterocyclic compound having a nitrogen atom;
X is an inert alkylsulfonate or perfluoride ion having no nucleophilicity;
Polystyrene is a copolymer consisting of styrene, styrene derivatives, or divinylbenzene.

2. quaternary ammonium polymer according to claim 1, wherein NR₃ is selected from the group consisting of trimethylamine, triethylamine, tri-n-propylamine, tri-n-butylamine, N-methylimidazole, and pyridine.

3. A quaternary ammonium polymer according to claim 1, wherein the X is selected from the group consisting of methanesulfonate (OMs), trifluoromethanesulfonate (OTf), para-toluenesulfonate (OTs), para-nitrobenzenesulfonate (ONs), tetrafluoroborate (BF₄), hexafluorophosphate (PF₆), hexafluoroantimonate (SbF₆), and N,N-bis(trifluoromethanesulfonyl)amide (N(Tf)₂).

4. A method for the preparation of neutral quaternary ammonium polymers of claim 1, wherein as an intermediate the quaternary ammonium polymer chlorides are prepared by a synthetic pathway selected from the group of the two synthetic pathways as shown in scheme 1: 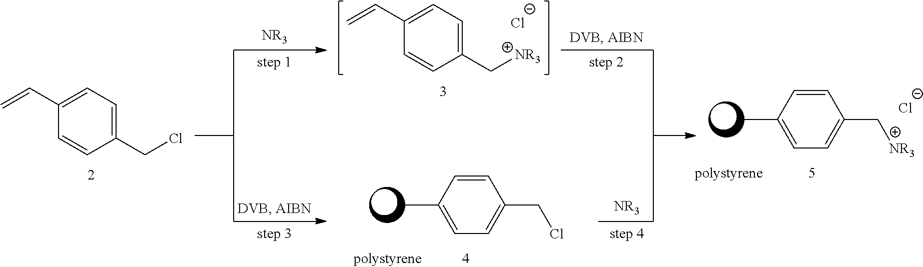
and the quaternary ammonium polymer of claim 1 is then obtained by anion exchange.

5. Method for the preparation of quaternary ammonium polymers of claim 1, wherein the quaternary ammonium polymer (1) is prepared in anion exchange manner by repeating shaking/filtration of a suspension of ammonium chloride polymer (5) in aqueous MX solution as shown in Scheme 2.

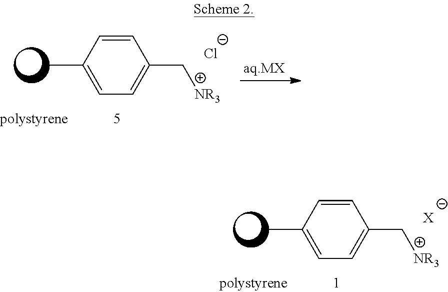

6. A polymer cartridge 6 containing neutral ammonium polystyrene of claim 1 for solid-phase anion extraction.

7. A method for separation of [¹⁸F]fluoride from aqueous solution, wherein [¹⁸F]fluoride dissolved in aqueous solution is passed through the polymer cartridge of claim 6.

8. A method for the preparation of an eluting solution for eluting [18F] from a cartridge according to claim 6, wherein the eluting solution is prepared by composing three ingredients (Ingredient A, Ingredient B, and Ingredient C), and dissolving in an alcohol solvent.

9. A method according to claim 8, wherein Ingredient A is K222 that is used as a phase transfer catalyst of [¹⁸F]fluorination in a range from 10 to 20 mg.

10. A method according to claim 8, wherein the alcohol solvent is selected from the group consisting of primary alcohol such as methanol, ethanol, n-propanol, n-butanol, n-pentanol, n-hexanol, n-heptanol, and n-octanol; or sencondary alcohol such as isopropanol, isobutanol, isoamyl alcohol, and 3-pentanol; or tertiary alcohol such as i-butanol, f-amyl alcohol, 2,3-dimethyl-2-butanol, 2-(trifluoromethyl)-2-propanol, 3-methyl-3-pentanol, 3-ethyl-3-pentanol, 2-emthyl-2-pentanol, 2,3-dimethyl-3-pentanol, 2,4-dimethyl-2-p e n to n o 1,2-methyl-2-hexanol, 2-cyclopropyl-2-propanol, 2-cyclopropyl-2-butanol, 2-cyclopropyl-3-methyl-2-butanol, 1-methylcyclopentanol, 1-ethylcyclopentanol, 1-propylcyclopentanol, 1-methylcyclohexanol, 1-ethylcyclohexanol, 1-methylcycloheptanol.

11. A process for releasing [¹⁸F]fluoride trapped in the polymer cartridge of claim 6, wherein [¹⁸F]fluoride trapped in the polymer cartridge is washed with distilled water (0.5-5.0 mL) and alcohol (0.5-5.0 mL) in sequence, and then eluted with the eluting solution prepared by composing three ingredients (Ingredient A, Ingredient B, and Ingredient C), and dissolving in an alcohol solvent.

12. A process for evaporation of the eluted solution containing [¹⁸F]fluoride, wherein the solution eluted out of the polymer cartridge by the process of claim 11 is heated at 60-120° C. with a gentle stream of N₂ or He gas and low vacuum for 1-3 min, and repeated after adding acetonitrile (0.5-1.0 mL) until all solvent including water is azeotropically removed entirely.

13. A process for nucleophilic [¹⁸F]fluorination, wherein nucleophilic [¹⁸F]fluorination is performed using [18F] obtained by a separation process using a quaternary ammonium polymer of claim 1.

14. A method according to claim 13, wherein precursors of [¹⁸F]-FDG, [¹⁸F]-CIT, [¹⁸F]FLT, [¹⁸F]-FMISO, [¹⁸F]-BAY94-9172, [¹⁸F]-FDDNP, or [¹⁸F]-AV-45 are fluorinated to obtain the respective [¹⁸F]-FDG, [¹⁸F]-CIT, [¹⁸F]-FLT, [¹⁸F]-F ISO, [¹⁸F]-BAY94-9172, [¹⁸F]-FDDNP, or [¹⁸F]-AV-45.

15. A process to separate and elute [¹⁸F]fluoride, and rapid evaporate a [¹⁸F]fluoride solution, comprising the following steps:
(a) Step 1—separation of [¹⁸F]fluoride ion using quaternary ammonium polymers of claim 1 by solid-phase extraction;
(b) Step 2-preparation of alcoholic solutions comprising K222, KOMs (or KOTf, or K₃PO4), and TBAHCO₃ (or TBAOH, or KOH, or K₂CO₃, or KHCO₃);
(c) Step 3—elution of an [¹⁸F]fluoride ion trapped on the polymer of Step 1 with an alcoholic solution of Step 3; and
(d) Step 4—evaporation of the [¹⁸F]fluoride solution obtained in Step 4;

16. A process to separate and elute [¹⁸F]fluoride, and rapid evaporate a [¹⁸F]fluoride solution, comprising the following steps:
(a) Step 1—preparation of a quaternary ammonium polymers of claim 1;
(b) Step 2—separation of [¹⁸F]fluoride ion using quaternary ammonium polymers of claim 1 by solid-phase extraction;
(c) Step 3—preparation of alcoholic solutions comprising K222, KOMs (or KOTf, or K₃PO₄), and TBAHCO₃ (or TBAOH, or KOH, or K₂CO₃, or KHCO₃);
(d) Step 4—elution of an [¹⁸F]fluoride ion trapped on the polymer of Step 1 with an alcoholic solution of Step 3; and
(e) Step 5—evaporation of the [¹⁸F]fluoride solution obtained in Step 4;

17. A method of nucleophilic [¹⁸F]fluorination comprising A process according to claim 15.

18. A method of claim 17, wherein precursors of [¹⁸F]-FDG, [¹⁸F]-CIT, [¹⁸F]-FLT, [¹⁸F]-FMISO, [¹⁸F]-BAY94-9172, [¹⁸F]-FDDNP, or [¹⁸F]-AV-45 are fluorinated to obtain the respective [¹⁸F]-FDG, [¹⁸F]-CIT, [¹⁸F]-FLT, [¹⁸F]-FMISO, [¹⁸F]-BAY94-9172, [¹⁸F]-FDDNP, or [¹⁸F]-AV-45.
